(19) United States
(12) Patent Application Publication
(10) Pub. No.: US 2013/0285383 A1
(43) Pub. Date: Oct. 31, 2013

(54) ENERGY GENERATION SYSTEM INCLUDING PONTOON UNIT AND WATER WHEEL

(71) Applicant: Mohamed Sahbi Belarbi, Malmo (SE)

(72) Inventor: Mohamed Sahbi Belarbi, Malmo (SE)

(21) Appl. No.: 13/820,908

(22) PCT Filed: Sep. 19, 2011
(86) PCT No.: PCT/SE11/51122

§ 371 Date: Jul. 8, 2013

(30) Foreign Application Priority Data
Sep. 24, 2010 (SE) 1050992-5

(51) Int. Cl. F03B 13/10; B63B 35/34

(52) U.S. Cl. CPC F03B 13/10; B63B 35/34
USPC 290/54; 114/267

(57) ABSTRACT

The present invention relates to a pontoon unit 1 intended for an energy generation system 2, said pontoon unit 1 comprising one first water surface pontoon part 3 having an unsymmetrical convexly curved inner surface X, a second water surface pontoon part 4 having an unsymmetrical convexly curved inner surface Y, and one bottom pontoon part 5 being substantially perpendicular to the first and second water surface pontoon parts 3, 4 and also having an unsymmetrical convexly curved inner surface Z.

### FIELD OF INVENTION

The present invention relates to a pontoon unit and a water wheel intended for an energy generation system, and also such an energy generation system.

### TECHNICAL BACKGROUND

Energy generation systems comprising some kind of pontoon or framework and water wheels exist today.

For example, US20070222219 discloses a hydroelectric device including generally a base portion with a top surface, a bottom surface, and opposing sidewalls defining an interior space of the base portion. The interior space of the base portion is such that it is wider near the ends of the base portion and narrower in the interior of the base portion, essentially forming a venturi. The base portion also includes a central slot along a longitudinal axis thereof. Furthermore, US20070222219 also discloses a wheel support portion fixedly attached to the base portion, a wheel portion rotatably attached to the wheel support portion and having a plurality of blades extending from a center thereof, and an electrical generator operably engaged with the wheel portion.

There are several drawbacks with the system disclosed in US20070222219. The first thing is the framework, which is not designed to be able to give a high energy output. The second thing is the stability of the system, where the framework disclosed in US20070222219 is more like a box than a pontoon which may be securely anchored. Furthermore, the water wheel is not optimized for a high energy output.

Generally, a water wheel is a device which uses free-flowing or falling water and turns it into different types of power. For example, water wheels are used for generating power in hydroelectric plants or for driving a mechanical process through the use of a water mill.

One problem with using this type of traditional water wheel system is that the wheel, and its surrounding structure, is firmly and more or less immovably arranged at one location. It is not an easy task to move the water wheel system, i.e. the water wheel and its surrounding structures, without much difficulty and labour.

One way of avoiding such immovability is using a water wheel system such as that which is disclosed in U.S. Pat. No. 1,368,454. This document reveals a system comprising of a number of water wheels and a number of floatation devices such as pontoons, hence significantly increasing the moveability of the structure.

One problem with this solution is that it is quite large and bulky, hence taking up much space in a water stream, e.g. a river, and during transportation. Also, this solution does not optimise the power output as compared to its size.

Another example of a water wheel is disclosed in U.S. Pat. No. 5,971,820. This document reveals a water wheel having one or more pairs of vanes placed around a vertical axle of rotation such that the vanes turn on a horizontal plane. DE202009012790 discloses another hydroelectric device where such horizontal water wheels are used.

Is should be noted that one important issue with using this type of horizontal water wheels is that actually only 50% of the water power is used due to the water wheel being constantly submerged.

The present invention aims at providing an energy generation system comprising a pontoon unit and at least one water wheel, having a very manageable size and, more importantly, showing an enhanced ability of generating power, i.e. giving a high power economy (efficiency). Furthermore, the present invention is directed to providing both an optimal pontoon unit and optimal water wheel for such an energy generation system.

### SUMMARY OF INVENTION

It is an object of the present invention to mitigate the above problems, and to provide an energy generation system, and its pontoon unit and at least on water wheel, assuring an as efficient power generation as possible. According to a first aspect of the present invention, these objects are achieved by a pontoon unit intended for an energy generation system, said pontoon unit comprising one first water surface pontoon part having an unsymmetrical convexly curved inner surface, a second water surface pontoon part having an unsymmetrical convexly curved inner surface, and one bottom pontoon part being substantially perpendicular to the first and second water surface pontoon parts and also having an unsymmetrical convexly curved inner surface, wherein the inner surface and inner surface are facing towards each other and all of the inner surfaces are facing towards the inside of the pontoon unit, and wherein the first water surface pontoon part and the second water surface pontoon part, respectively, is joined together with the bottom pontoon part so as to form one single pontoon unit having a water flow channel.

As is clear from FIG. 1, the water surface pontoon parts are those which may be seen from the water surface, although they may be vertically adjustable, as discussed below.

When viewing FIG. 1, the single pontoon unit may be seen, and is clear that the pontoon unit is one single piece, however comprising different parts. As notable from FIG. 1, the first and second water surface pontoon parts are joined together with the bottom pontoon part along the entire length of the first and second water surface pontoon parts as well as bottom pontoon part, which is preferred.

As described above, a water flow channel is formed inside of the pontoon unit according to the present invention. In view of the unsymmetrical convexly curved inner surfaces of the pontoon unit, a concentration of the water flow is achieved, which renders an optimal venturi shape for generating energy in a system.

There are different aspects which are important to achieve an optimal design of the pontoon unit. Firstly, there must exist a concentration of the water flow going into the pontoon unit. The pontoon unit may be said to have a venturi shape. This is however not enough. Furthermore, the venturi shape should not be symmetrical. The inner surface of the side of the pontoon unit meeting the water flow should have a steeper curvature or bending than the part of the inner surface being the outflow side, i.e. after the place intended to hold the water wheel. Such an unsymmetrical shape is not disclosed for the box design shown in US20070222219. Therefore, it is not possible to achieve an efficiency level obtainable by the present invention from the device disclosed in US20070222219.

There are also other aspects which may be of relevance for the possible most optimal shape of the pontoon unit, but also the water wheel. This is discussed in more detail below.

### BRIEF DESCRIPTION OF THE DRAWINGS

Different aspects of the present invention will now be described in more detail, with reference to the appended drawings showing a currently preferred embodiment of the invention.

FIG. 1 shows a perspective view of the energy generation system according to the present invention, seen from the front.

FIG. 2 shows a top view of the energy generation system according to the present invention, where the bottom pontoon part is not shown.

FIG. 3 shows a water wheel according to the present invention.

### DETAILED DESCRIPTION OF THE INVENTION

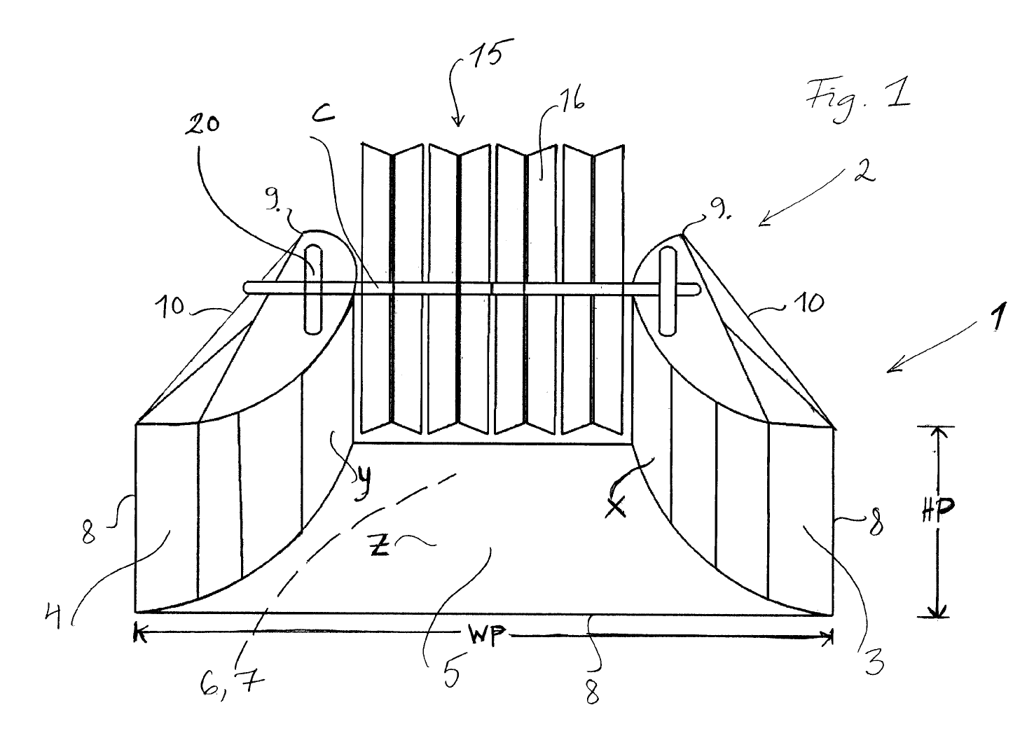

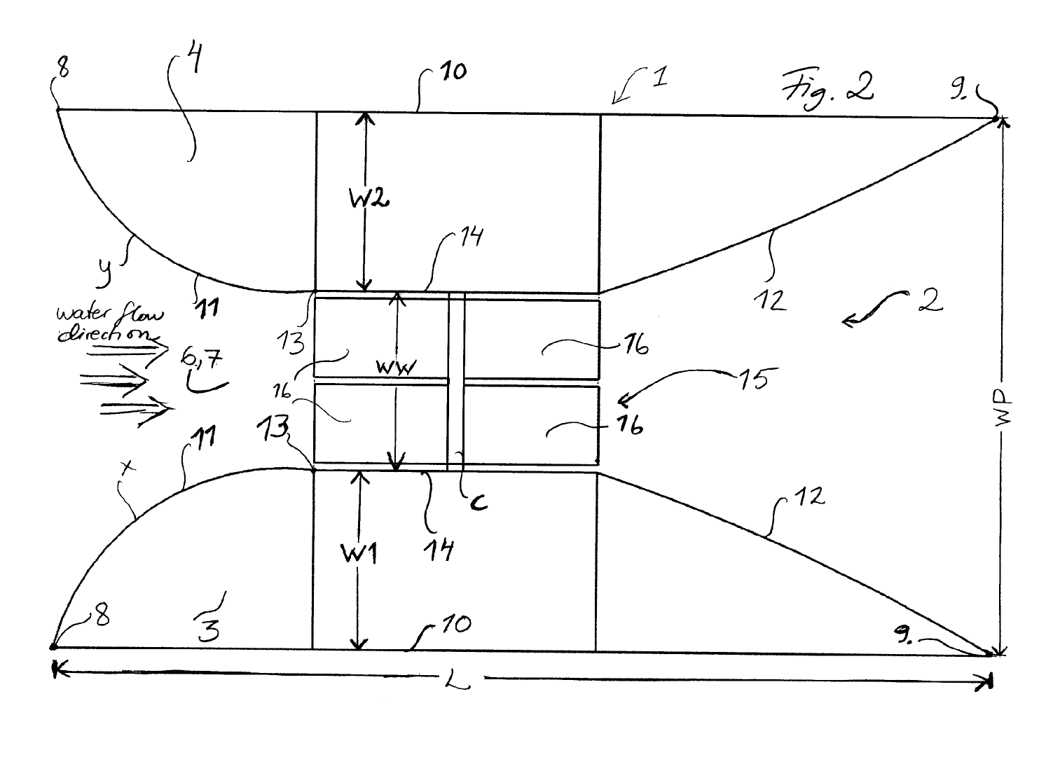

According to one embodiment of the present invention, the first water surface pontoon part 3 and the second water surface pontoon part 4 have substantially the same geometrical shape and are mirror-inverted arranged to each other. This may be seen in FIG. 1 and FIG. 2. According to another embodiment, each pontoon part is pointed at the front end and at the rare end. This is of importance to keep the water flowing resistance as low as possible. Furthermore, according to one specific embodiment, each pontoon part has a substantially straight long side, said long side being the side facing away from the inner of the pontoon unit. In FIGS. 1 and 2 such water surface pontoon parts having both pointed ends and straight long sides may be seen, however the same shape is preferred also for the bottom pontoon part. The straight longs sides are of interest for having as short water distance on the non-water wheel side as possible. This gives rise to as large difference as possible between water distance on the water wheel side and water distance on the outside of the pontoon unit, which in turn is one parameter to obtain optimal energy generation in the system.

As hinted above, according to one specific embodiment of the present invention, at least one, however preferably all of, the unsymmetrical convexly curved inner surfaces is shaped so that a front side portion is more bent than a rear side portion, the front side being the side intended to meet the water flow direction. Moreover, according to another specific embodiment, at least one of the unsymmetrical convexly curved inner surfaces may be divided into one front side portion extending from the front end to a levelling point, one substantially plane portion being substantially parallel to the long side and one rear side portion bending back to the rear end. This shape is clearly shown in FIG. 2. This shape gives rise to an optimal design in relation to the concentration of the inflow of water, i.e. the venture shape, inside of the pontoon unit, an optimal plane design where the water wheel is intended to be placed, a good water releasing design behind the water wheel as well as a large difference between water distance on the water wheel side and water distance on the outside of the pontoon unit discussed above. It should be noted that the tapered shape of the water passage increases the water speed significantly, at least 50% but up to 140%.

When all of these aspects are incorporated in the pontoon unit according to the present invention, the behavior of the pontoon unit and the water flow appearance behind the water wheel may be compared to that of a propeller engine submerged into water. The water level behind the water wheel is lower than on the inflow side, in fact almost the half level, and behind the water wheel it looks like a water wave is created and the water “jumps over” the meeting water which has flowed outside of and around the pontoon unit. This is proof of very good water flow conditions for achieving high energy generating output.

To give some examples of different measures of the pontoon unit according to the present invention, the following may be said. According to one specific embodiment of the present invention, at least one of, and preferably all of, the unsymmetrical convexly curved inner surfaces has a front side portion extending from the front end to a levelling point being positioned at 10-30% of the entire length of one long side of the specific pontoon part. It should be noted that it may be only one of the inner surfaces having this design, but preferably all of the inner surfaces have it. Moreover, it should also be understood that the measure at 10-30% of the entire length, is measured as a parallel length to the long side and not as a bent length from the front end to the levelling point. One example is 20% of the entire length. According to one embodiment, at least one of, and preferably all of, the unsymmetrical convexly curved inner surfaces have a plane portion occupying 30-50% of the entire length of one long side of one pontoon part and a rear side portion occupying 30-50% of the entire length of one long side of one pontoon part. These lengths should also be measured as parallel lengths to the long side and for the rear side portion not as a bent length. Moreover, it should be clear that plane portion cannot occupy 50% of the entire length of the long side when the rear side portion occupies 50% of the entire length of the long side, as this would exclude a front side portion, which is not of interest. One interesting example of the entire lengths is a front side portion to a plane portion to a rear side portion of about 1:2:2.

According to another embodiment of the invention, the largest width of the first water surface pontoon part and/or the largest width of the second water surface pontoon part has a factor from 0.8 to 1.2 in relation to the smallest width of the water flow channel formed between the first and second water surface pontoon parts. Typically is a ration of about 1:1:1 for these widths.

According to one specific embodiment of the pontoon unit according to the present invention, the height*length*width of the entire pontoon unit is in the ratio of from (3*10*5) meters to (6*30*20) meters. One example is a pontoon unit having a height of about 5 meters, a length of about 20 meters and a width of about 15 meters, where the water flow channel at the water wheel position may be about 5 meters in width.

Furthermore, it should be noted that the different pontoon unit parts also may be built up by different portions which have been joined together. One possibility is pontoon parts having different sections, e.g. each being hollow and possible to fill with e.g. water for achieving floating property.

Moreover, the pontoon unit according to the present invention may comprise more pontoon parts, such as e.g. a double pontoon unit having a first, a second and also a third water pontoon part, where the second water pontoon part is a middle water surface pontoon part and must as such have unsymmetrical convexly curved surfaces on both sides. In such a double pontoon unit one may see it as also having two bottom pontoon parts, one on each side of the second or middle water surface pontoon unit.

Furthermore, the pontoon units are preferably made of stainless steel, fibreglass, or plastic. Moreover, the pontoon unit can be connected to a guay or any similar stationary element, or to other pontoon units.

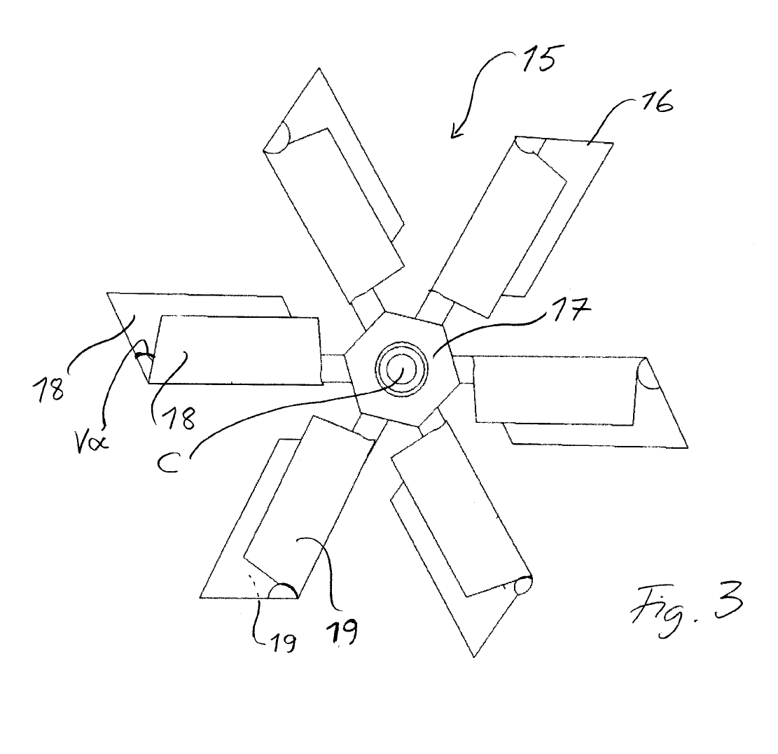

The present invention is also directed to providing an optimal water wheel design for an energy generation system. According to one embodiment of the present invention, there is provided a water wheel for an energy generation system, said water wheel comprising at least two vanes being placed around the periphery of a rotatable, tubular centre hub, a proximal end of each vane being connected to a periphery of the centre hub and said vanes extending in radial direction from a centre axis of the centre hub such that a distal end of each vane is a free end, wherein each vane has a V-shape formed by two vane portions arranged with an angle Vα to each other. In FIG. 3, a water wheel according to the present invention is shown, where the water wheel has 6 V-shaped vanes.

Also with the water wheel, the design is of importance for optimal energy generation capability. Firstly, the vanes must be sharp, and that is why the V-shape is preferred on both front and back side. As such the vanes may cut the water surface with as little resistance as possible. The V-shaped design of the vane facilitates a more efficient interaction with the approaching water stream, since that shape of the vane forms walls which enclose the water more efficiently, and provides the vanes also with a larger surface area, than e.g. a flat vane. This results in a larger force acting upon each vane, causing the wheel to rotate faster, and more power to be generated.

According to one specific embodiment, the two vane portions of each vane have substantially the same geometrical shape and size so that the angle Vα formed is in the middle of each vane. This is shown in FIG. 3. According to yet another specific embodiment, the angle Vα is in the ratio of from 80 to 100 degrees, preferably about 90 degrees.

Furthermore, according to another embodiment, each vane has at least substantially the same width all the way from the distal end to the proximal end. This is also in relation to giving maximum yield but still having a sustainable structure.

According to an embodiment, the back surface of the vane is provided with dimples in order to reduce the water friction on the back surface. Such dimples may also be provided on any of the pontoon unit surfaces.

The water wheel may have at least 3 vanes, such that the water wheel has one vane submerged into the water stream constantly. As seen in FIG. 1, about 5 or 6 vanes per water wheel may be a suitable amount.

The water wheel may be reinforced by each vane being connected to both adjacent vanes thereof, for example by using a suitable type of cross member, each cross member e.g. being arc shaped such that all cross members together form a visual circle around the centre axis C of the centre hub. This is of interest when the vanes are e.g. at least 3 meters in length and therefore a reinforcement of the entire structure may be of importance. It should be noted that the vanes could be of any suitable length, depending on the depth of the water stream, the size of the energy generation system in which the water wheel is part, and other limiting factors. Moreover, the vanes are preferably made of stainless steel, fibreglass, or plastic.

The water wheel disclosed in US20070222219 has vanes with an U-shape. Although they are said to have a V-shape, what is meant is in fact a convexly shaped inner surface, i.e. without the forming of an angle along the inner surface. This may be seen from the figures in US20070222219, but also when viewing the description. Although such an U-shape may function for the vanes in a water wheel for an energy generation system, the V-shape suggested according to the present invention has proven to be more effective. The vanes according to the present invention are sharp and each forms an angle on the inner surface, which in turn keeps the resistance as low as possible.

There are also other aspects which are important in relation to the water wheel and the entire energy generation system according to the present invention. The first thing is the placement of the water wheel. As understood from looking at FIGS. 1 and 2, the water wheel is placed so that more or less half of it is in water, and the second half is in the air. This is an optimal placing of the water wheel. All energy generation units may be said to have a positive and a negative side, the positive being the driver for energy generation and the negative side being the resistance side. According to the present invention, the positive side is the vanes being placed in the water stream, and the negative side is the vanes being up in the air. As water has a density of about 830 times the density of air, the positive side is much stronger than the negative side according to the present invention. When compared to e.g. the solutions disclosed in U.S. Pat. No. 5,971,820 or DE202009012790, the vertical rotation of the water wheel according to the present invention, where the positive side in the water and the negative side up in the air, is a very important improvement for the possible energy yield. In this context, it may be said that efficiency levels above 60% have been measured with a system according to the present invention.

It should also be noted that an energy generation system according to the present invention may comprise several water wheels, e.g. at least two or three such in series. In FIG. 1, the system comprises four water wheels, and in FIG. 2, the system comprises two water wheels.

The water wheel(s) according to the present invention may also be provided with protective hood(s) that over at least a portion of the water wheel which is not submerged, in order to protect the water wheel(s) from snow or ice, from debris, and for protecting any humans or animals in the vicinity of the rotating water wheel(s).

According to the present invention, there is also provided an energy generation system, said system comprising a pontoon unit according to the present invention, at least one water wheel, at least one generator, and a frame work connecting said water wheel, pontoon unit and generator by an axle so that the at least one water wheel is movable around said axle and substantially perpendicular to the water flow channel, so that energy may be generated in the generator, wherein said system being adapted for submerging at least partially in water. Such a system is disclosed in FIG. 1. The generator could be of any suitable type, such as a generator with a gear box or a generator which is mounted directly on the water wheel axle.

Furthermore, since the power generated by the water wheel depends on i.a. the speed of the passing water, this significant increase in water speed results in a significant increase of generated power. The water wheel is preferably placed close to or at the most tapered section of the water flow passage, such as at a plane section disclosed in FIG. 2.

According to one specific embodiment, the energy generation system is vertically adjustable. This may be achieved by the system having a framework which is vertically adjustable, such as by having axles connected to a quay and having joints so that the framework and system may be lifted and lowered. As such, the system may be partially floating so that the bottom pontoon part is freely arranged from the bottom of a river. This may also be achieved by other means of anchoring than the framework being connected to a quay. When the frame work is vertically adjustable, the system can easily be adapted to different water stream conditions such as ebb or tide.

Moreover, as said, the pontoon units may be floating by having hollow portions, e.g. partly filled with eater. Furthermore, it should be noted that the bottom pontoon part may be fixedly and securely anchored to the bottom also.

As probably understood from above, according to one embodiment of the present invention, the energy generation system comprises at least one water wheel according to the present invention and disclosed above.

There may also be other aspects which should be considered in relation to the present invention. First of all, the energy generation system may be provided as an energy generation kit which is adapted for being foldably enclosed within a container during transportation. This is of course in order to save room during transportation and to avoid the need for assembly when having arrived at the intended location.

Such a kit may also comprise other accessories, such as one or several coverings or protective hoods intended for the water wheel(s) and also e.g. a net device intended to be placed in the river as a barrier protection for taking care of e.g. timber or other kind of junk which one does not want to enter the energy generation system together with the water stream inflow. Such a net device may be e.g. a steel construction placed at the water surface with the net being submerged at least a distance in the water. The important thing is of course to ensure that the water flows through the net protection, however that junk or timber is stopped or made to bounce away so that it cannot enter the energy generation system together with the water stream.

### DETAILED DESCRIPTION OF THE DRAWINGS

FIG. 1 shows an energy generation system 2 comprising a pontoon unit 1 according to the present invention. The pontoon unit 1 comprises one first water surface pontoon part 3 having an unsymmetrical convexly curved inner surface X, a second water surface pontoon part 4 having an unsymmetrical convexly curved inner surface Y, and one bottom pontoon part 5 being substantially perpendicular to the first and second water surface pontoon parts 3, 4 and also having an unsymmetrical convexly curved inner surface Z, wherein the inner surface X and inner surface Y are facing towards each other and all of the inner surfaces X, Y, Z are facing towards the inside 6 of the pontoon unit 1, and wherein the first water surface pontoon part 3 and the second water surface pontoon part 4, respectively, is joined together with the bottom pontoon part 5 so as to form one single pontoon unit 1 having a water flow channel 7. Each pontoon part 3, 4, 5 is pointed at the front ends 8 and at the rare ends 9. Moreover, each pontoon part 3, 4, 5 has a substantially straight long side 10, said long side 10 being the side facing away from the inner 6 of the pontoon unit 1. Furthermore, the total width of the pontoon unit is marked as WP and the height is marked as HP.

In FIG. 1, you may also see four water wheels 15, each comprising several vanes 16, and together having the centre axle C connected to at least one generator 20. The water flow direction should be seen as passing the water wheel and through the figure. When the water wheel 15 is rotated around the axis C, the axle C also rotates and as such energy is generated in the connected generator 20.

FIG. 2 also shows an energy generation system 2 according to the one shown in FIG. 1, however seen from the top. The bottom pontoon part 5 has been removed from the figure, so the figure may in fact be seen as a top cross section. The arrows show the water flow direction. As notable in FIG. 2, the unsymmetrical convexly curved inner surface X and the unsymmetrical convexly curved inner surface Y are shaped so that the front side portion 11 is more bent than the rear side portion 12, the front side being the side intended to meet the water flow direction. Moreover, the inner surfaces X and Y may be divided into one front side portion 11 extending from the front end 8 to a levelling point 13, one substantially plane portion 14 being substantially parallel to the long side 10 and one rear side portion 12 bending back to the rear end 9. This shape is preferable to achieve optimal venturi and power generation effect and also for enabling good positioning of the two water wheels 15.

Also shown in FIG. 2 is the entire length L of the pontoon unit as well as the largest width W1 of the first water surface pontoon part 3 and the largest width W2 of the second water surface pontoon part 4, which preferably has a factor from 0.8 to 1.2 in relation to the smallest width WW of the water flow channel 7. For example W1, W2 and WW may be the same length, such as e.g. 5 metres each. The entire length may e.g. be 20 metres.

In FIG. 3 there is shown a water wheel 15 according to the present invention. The water wheel 15 comprises six vanes 16 being placed around the periphery of a rotatable, tubular centre hub 17, a proximal end of each vane 16 being connected to a periphery of the centre hub 17 and said vanes 16 extending in radial direction from a centre axis C of the centre hub 17 such that a distal end of each vane 16 is a free end, where each vane 16 has a V-shape formed by two vane portions 18 arranged with an angle Vα to each other. The back surfaces 19 of the vanes 16 are also shown.

The person skilled in the art realizes that the present invention by no means is limited to the preferred embodiments described above. On the contrary, many modifications and variations are possible within the scope of the appended claims. For example, any type or number of water wheels, generators and/or pontoon units could be used. Further, the systems could be interconnected such that several systems can be used not only after one another along the quay but also in a perpendicular direction from the quay. Also, the vanes of the water wheel and the pontoons can be made of any material suitable for submerging.

1. Pontoon unit (1) intended for an energy generation system (2), said pontoon unit (1) comprising one first water surface pontoon part (3) having an unsymmetrical convexly curved inner surface (X), a second water surface pontoon part (4) having an unsymmetrical convexly curved inner surface (Y), and one bottom pontoon part (5) being substantially perpendicular to the first and second water surface pontoon parts (3, 4) and also having an unsymmetrical convexly curved inner surface (Z), wherein the inner surface (X) and inner surface (Y) are facing towards each other and all of the inner surfaces (X, Y, Z) are facing towards the inside (6) of the pontoon unit (1), and wherein the first water surface pontoon part (3) and the second water surface pontoon part (4), respectively, is joined together with the bottom pontoon part (5) so as to form one single pontoon unit (1) having a water flow channel (7).

2. Pontoon unit (1) according to claim 1, wherein the first water surface pontoon part (3) and the second water surface pontoon part (4) have substantially the same geometrical shape and are mirror-inverted arranged to each other.

3. Pontoon unit (1) according to claim 1 or 2, wherein each pontoon part (3, 4, 5) is pointed at the front end (8) and at the rare end (9).

4. Pontoon unit (1) according to any of claims 1-3, wherein each pontoon part (3, 4, 5) has a substantially straight long side (10), said long side (10) being the side facing away from the inner (6) of the pontoon unit (1).

5. Pontoon unit (1) according to any of claims 1-4, wherein the unsymmetrical convexly curved inner surface (X), the unsymmetrical convexly curved inner surface (Y), and/or unsymmetrical convexly curved inner surface (Z) are shaped so that a front side portion (11) is more bent than a rear side portion (12), the front side being the side intended to meet the water flow direction.

6. Pontoon unit according to claim 5, wherein the unsymmetrical convexly curved inner surface (X), the unsymmetrical convexly curved inner surface (Y), and/or unsymmetrical convexly curved inner surface (Z) may be divided into one front side portion (11) extending from the front end (8) to a levelling point (13), one substantially plane portion (14) being substantially parallel to the long side (10) and one rear side portion (12) bending back to the rear end (9).

7. Pontoon unit (1) according to claim 5 or 6, wherein the unsymmetrical convexly curved inner surface (X), the unsymmetrical convexly curved inner surface (Y), and/or unsymmetrical convexly curved inner surface (Z) have a front side portion (11) extending from the front end (8) to a levelling point (13) being positioned at 10-30% of the entire length (L) of one long side (10) of one pontoon part (3, 4, 5).

8. Pontoon unit (1) according to claim 6 or 7, wherein the unsymmetrical convexly curved inner surface (X), the unsymmetrical convexly curved inner surface (Y), and/or unsymmetrical convexly curved inner surface (Z) have a plane portion (14) occupying 30-50% of the entire length (L) of one long side (10) of one pontoon part (3, 4, 5) and a rear side portion (12) occupying 30-50% of the entire length (L) of one long side (10) of one pontoon part (3, 4, 5). 25

9. Pontoon unit according to any of the preceding claims, wherein the largest width (W1) of the first water surface pontoon part (3) and/or the largest width (W2) of the second water surface pontoon part (4) has a factor from 0.8 to 1.2 in relation to the smallest width (WW) of the water flow channel (7) formed between the first and second water surface pontoon parts (3, 4).

10. Pontoon unit (1) according to any of the preceding claims, wherein the height (HP)*length (L)*width (WP) of the entire pontoon unit is in the ratio of from (3*10*5) meters to (6*30*20) meters.

11. Water wheel (15) for an energy generation system (2), said water wheel (15) comprising at least two vanes (16) being placed around the periphery of a rotatable, tubular centre hub (17), a proximal end of each vane (16) being connected to a periphery of the centre hub (17) and said vanes (16) extending in radial direction from a centre axis (C) of the centre hub (17) such that a distal end of each vane (16) is a free end,
characterised by each vane (16) having a V-shape formed by two vane portions (18) arranged with an angle (Vα) to each other.

12. Water wheel (15) according to claim 11, wherein the two vane portions (18) of each vane (16) have substantially the same geometrical shape and size so that the angle (Vα) formed is in the middle of each vane (16).

13. Water wheel (15) according to claim 11 or 12, wherein the angle (Vα) is in the ratio of from 80 to 100 degrees.

14. Water wheel (15) according to any of claims 11-13, wherein each vane (16) has at least substantially the same width all the way from the distal end to the proximal end.

15. Water wheel (15) according to any of claims 11-14, wherein the back surface (19) of the vane (16) is provided with dimples.

16. Water wheel (15) according to any of claims 11-15, wherein the water wheel (15) has at least 3 vanes (16).

17. Water wheel (15) according to any of claims 11-16, wherein the water wheel (15) is reinforced by each vane (16) being connected to both adjacent vanes (16) thereof.

18. Energy generation system (2), said system (2) comprising a pontoon unit (1) according to any of claims 1-11, at least one water wheel (15), at least one generator (20), and a frame work connecting said water wheel (15), pontoon unit (1) and generator (20) by an axle (C) so that the at least one water wheel (15) is movable around said axle (C) and substantially perpendicular to the water flow channel (7), so that energy may be generated in the generator (20), wherein said system (2) being adapted for submerging at least partially in water.

19. Energy generation system (2) according to claim 18, which is vertically adjustable.

20. Energy generation system (2) according to claim 18 or 19, which is partially floating so that the bottom pontoon part (5) may be freely arranged from the bottom of a river.

21. Energy generation system (2) according to any of claims 18-20, comprising at least one water wheel (15) according to any of claims 12-18.
